(19) United States
(12) Patent Application Publication
(10) Pub. No.: US 2025/0086131 A1
(43) Pub. Date: Mar. 13, 2025

(54) METHOD AND SYSTEM

(71) Applicant: Liebherr-Aerospace Lindenberg GmbH, Lindenberg (DE)

(72) Inventors: Cornelius FINK, Langen bei Bregenz (AT); Thomas DEDLER, Lindenberg (DE)

(21) Appl. No.: 18/825,615

(22) Filed: Sep. 5, 2024

(30) Foreign Application Priority Data
Sep. 7, 2023 (DE) 10 2023 124 158.3

(51) Int. Cl. G06F 13/38

(52) U.S. Cl. CPC G06F 13/38; G06F 2213/40

(57) ABSTRACT

The present disclosure relates to a computer-implemented method for transmitting data, in particular in a flight control, comprising the steps of:
transmitting a synchronisation signal via a first processing unit;
receiving the synchronisation signal by a second and/or a third processing unit, at a receiving timepoint in each case;
transmitting first data from the third processing unit to the second processing unit, wherein the transmission of the first data takes place at a first transmission timepoint which depends on the respective receiving timepoint of the reception of the synchronisation signal by the second and/or third processing unit;
transmitting the first and/or second data from the second processing unit to the first processing unit, wherein the transmission takes place at a second transmission timepoint which depends on the respective receiving timepoint of the reception of the synchronisation signal by the second and/or third processing unit.

### CROSS REFERENCE TO RELATED APPLICATION

The present application claims priority to German Patent Application No. 10 2023 124 158.3 filed on Sep. 7, 2023. The entire contents of the above-listed application are hereby incorporated by reference for all purposes.

### TECHNICAL FIELD

The present disclosure relates to a computer-implemented method for transmitting data, in particular in a flight control.

### BACKGROUND

Systems and system architectures are known from the prior art for transmitting data between processing units or for reading data into a processing unit from a plurality of other processing units.

### SUMMARY

Such systems are known for example in flight controls or flight control computers (FCC).

FIG. 3 shows an example for a known system or a known system architecture.

In this case, a plurality of second processing units 2, for example in each case in the form of a field programmable gate array (FPGA) is in each case electrically connected to a first processing unit 1, for example in the form of a central processing unit (CPU), via a high speed data bus B.

The high speed data bus 3 thus serves in each case for electrical connection of the second processing units 2 to the first processing unit 1.

It is thus known that individual second processing units, e.g. FPGAs, are connected via a high speed data bus to a first processing unit, e.g. a CPU, as a result of which each second processing unit can be controlled and/or read out individually by the first processing unit.

A high speed data bus B is thus an electrical interface of the first processing unit 1, wherein the first processing unit 1 comprises three electrical interfaces. The second processing unit 2, shown by dashed lines in FIG. 3, can optionally be connected to the first processing unit 1 via the high speed data bus B (shown in dashed lines).

The first processing unit 1, e.g. the CPU, is thus the master of the communication and comprises the corresponding number of high speed data buses B, in order to connect the second processing units 2, e.g. FPGAs, as slaves of the communication. The limited number of high speed data buses B, which can comprise a first processing unit, results in a limitation of the maximum number of connectable second processing units 2. This consequently limits the number of electrical interfaces or connections, for example for sensors, which the system can have, e.g. in an FCC.

Furthermore, the outlay for the processing of the data in the first processing unit 1, e.g. the CPU, is higher if a plurality of high speed data buses B are controlled or processed. This for example reduces the performance of the first processing unit and increases the runtime for the processing of the data.

For example in order to reduce costs, it is desirable, in systems or system architectures, in particular of flight controls, to reduce the number of computers and to increase the number of functions per computer.

It follows from this that systems or system architectures should comprise fewer computers, which, however, are more complex viewed individually. This results in higher demands on the processing power or performance of the CPUs or first processing units of the computers, and an increased number of electrical interfaces, which are read in and processed by a computer or a CPU or a first processing unit.

It is desirable for systems, in particular in FCC, to exhibit highly deterministic behaviour with respect to the execution of software, as well as with respect to the processing of the electrical interfaces, e.g. when reading in from sensors, actuating outputs, etc. In order to ensure this, a deterministic data transmission, from the electrical input, beyond a signal processing chain, having a low latency and a small temporal fluctuation range (jitter) is required.

In order to keep system delays at a minimum, in particular very high demands are placed on the latency. In particular in the case of longer transmission paths, e.g. beyond a plurality of FPGAs, a matched configuration is necessary, in order to keep the latency and also the temporal fluctuation width (jitter) as low as possible.

Against this background, the object of the present disclosure is that of providing a method that is improved compared with the method mentioned above, in particular in order to connect an increased number of processing units to the first processing unit with a limited number of electrical interfaces.

This object is achieved by the method having the features of independent claim 1. The dependent claims relate to advantageous developments of the disclosure.

Accordingly, the following is provided according to the disclosure: a computer-implemented method for transmitting data, in particular in a flight control, comprising the steps of:
transmitting a synchronisation signal via a first processing unit;
receiving the synchronisation signal by a second and/or a third processing unit, at a receiving timepoint in each case;
transmitting first data from the third processing unit to the second processing unit, wherein the transmission of the first data takes place at a first transmission timepoint which depends on the respective receiving timepoint of the reception of the synchronisation signal by the second and/or third processing unit;
transmitting the first and/or second data from the second processing unit to the first processing unit, wherein the transmission takes place at a second transmission timepoint which depends on the respective receiving timepoint of the reception of the synchronisation signal by the second and/or third processing unit.

The term “timepoint” is optionally to be interpreted broadly within the context of the disclosure, and for example also includes a time portion or time period.

In other words, a transmission of data of any processing unit to a first processing unit optionally takes place via one or more further processing units.

As a result, data of any number of processing units can be transmitted to the first processing unit via a single electrical interface and/or a single data channel, e.g. a pin or port of said first processing unit.

It is optionally provided that the first transmission timepoint is a sum of the receiving timepoint of the receiving of the synchronisation signal by the second and/or third processing unit, a first time offset, and/or a time duration, in particular of a collection of the first data, and/or in that the second transmission timepoint is the sum of the receiving timepoint of the receiving of the synchronisation signal by the second and/or third processing unit, a second time offset, and/or a time duration, in particular of a collection of the second data.

It is optionally provided that the method comprises the step, before transmitting of first data from the third processing unit to the second processing unit, of:
collecting the first data by means of the third processing unit.

It is optionally provided that the method comprises the step, before transmitting of the first data and/or of the second data from the second processing unit to the first processing unit, of:
collecting the second data by means of the second processing unit.

The collecting of data includes for example reading out a sensor, etc.

It is optionally provided that the collecting of the first data takes place at a first collection timepoint, which is a sum of the receiving timepoint of the receiving of the synchronisation signal by the second and/or third processing unit, and of the first time offset, and/or in that the collecting of the second data takes place at a second collection timepoint, which is a sum of the receiving timepoint of the receiving of the synchronisation signal by the second and/or third processing unit, and of the second time offset.

It is optionally provided that the transmission of the first and/or of the second data from the second processing unit to the first processing unit takes place via exactly one data channel, in particular a high speed data bus.

The data channel optionally comprises an electrical interface.

A signal transmission of the synchronisation signal via the data channel and/or via a signal channel can take place between the sending and the receiving of the synchronisation signal.

It is optionally provided that the steps of the method are carried out multiple times, in particular periodically.

It is optionally provided that the first and/or the second transmission timepoint is adjusted, in particular to a latency of the third and/or second processing unit in each case.

The disclosure also relates to a system comprising a first, second and third processing unit, which are in each case configured so as to carry out a method according to the disclosure.

The system optionally comprises a plurality of processing units, the data of which can all be transmitted to the first processing unit via a single data channel or an electrical interface.

The processing units are optionally interconnected in a communicative manner, for example wired, e.g. via pins.

It is optionally provided that the first, second and/or third processing unit in each case comprise or constitute a processor, in particular a CPU, an FPGA and/or an ASIC.

In particular, the second and/or third processing units can for example each comprise or constitute an interface component, an input/output component, a field programmable gate array (FPGA), and/or an application specific integrated circuit (ASIC). The second and/or third processing units can each comprise an electrical port, for example for integrating a sensor.

It is optionally provided that the first, second and/or third processing unit are connected directly, i.e. without intermediate components and/or a further processing unit, or indirectly, i.e. at least once in pairs via an intermediate component and/or a further processing unit, in particular in each case via a data channel, in particular a high speed data bus.

The high speed data bus ca e.g. be a peripheral component interconnect express (PCIe).

It is optionally provided that the system is a component of a flight control of an aircraft, in particular an aeroplane.

The disclosure also relates to a computer programme which comprises commands which cause the system according to the disclosure to carry out the method steps of the method according to the disclosure.

The disclosure also relates to a computer-readable medium, on which the computer programme according to the disclosure is stored.

The processing units, the data channel and/or the signal channel optionally comprise or form a synchronised transmission path for transmission of data, wherein in particular there is a possibility for optimising a latency by pre-processing the data at as late a timepoint as possible, in particular by adjusting a time offset. The system is for example an architecture, which comprises transmission paths having a plurality of points.

Optionally synchronous data transmission takes place, in order to minimise a latency of the data transmission.

The disclosure optionally has the following advantages:
optionally, a smallest possible latency and a smallest possible jitter are present;
optionally, an adjustment to the amount of data to be transmitted takes place by means of an adjustment of a time offset;
optionally, there is a possibility for adjusting the transmission timepoint(s) at which a transmission takes place, in particular depending on the respective processing unit;
optionally, a compensation of line lengths of lines, data channels and/or signal channels, which transmit the synchronisation signal or the data, and/or an amount of data to be transmitted and accordingly a duration of a preparation of the data to be transmitted, can take place;
optionally a processing outlay is reduced compared with a “star architecture”, as is shown for example in FIG. 3, in which a plurality of busses are controlled or processed by the first processing unit. This for example increases the performance of the first processing unit and reduces the runtime for the processing of the data;
there is optionally no limitation on account of the availability and/or the number of data busses of the first processing unit, e.g. the CPU;
The system can optionally be extended in a flexible manner, in particular with further processing units, in particular without impairing a software architecture and/or of software drivers.

At this point, it is noted that the terms “a” and “an” do not necessarily refer to precisely one of the elements, even if this is shown by a possible embodiment, but rather can also denote a plurality of the elements. Likewise, the use of the plural also includes the presence of the element in question in the singular, and, vice versa, the singular also includes a plurality of the elements in question. Furthermore, all the features of the disclosure described herein can be combined with one another as desired, or claimed in isolation from one another.

### BRIEF DESCRIPTION OF THE FIGURES

Further advantages, features and effects of the present disclosure emerge from the following description of preferred embodiments, with reference to the figures, in which identical or similar components are denoted by the same reference signs. In this case:

FIG. 1: is a flow diagram of an embodiment of a method according to the disclosure.

FIG. 2: is a schematic block diagram of an embodiment of a system according to the disclosure.

FIG. 3: is a schematic block diagram of an embodiment of a system known from the prior art.

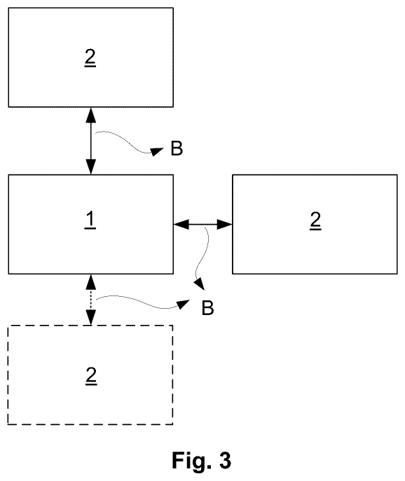

### DETAILED DESCRIPTION

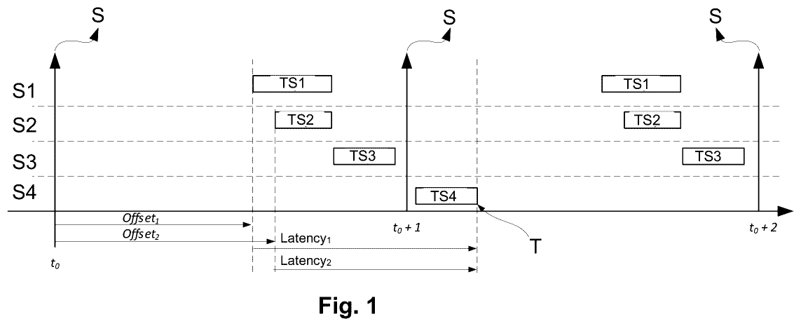

FIG. 1 shows a temporally optimised course of an embodiment of the method according to the disclosure, wherein a synchronisation signal S is sent from a first processing unit to a second and third processing unit, and received by the second and third processing unit, and wherein data are transmitted from the third to the second and from the second processing unit to the first processing unit. The processing units may include a processor and memory with instructions stored therein to carry out the operations as described herein, as well as hardware to send and receive the transmitted signals as described herein.

The graph in FIG. 1 has a time bar shown by a horizontally extending arrow, over which the steps of the method S1 to S4 are plotted in lines.

The vertically extending arrows show the timepoints of the sending of the synchronisation signals S by the first processing unit, and the receiving timepoints of the receiving of the synchronisation signals S by the second and third processing unit.

The first processing unit is a master, and the second and third processing unit are in each case slaves.

The synchronisation signal S is sent and received periodically.

At the timepoints t₀, t₀+1, t₀+2 etc., wherein 1, 2, etc. are counters for the individual periods at which a synchronisation signal S is sent, in each case a synchronisation signal S is sent and received.

By way of example, a course of the method for the first period takes place as follows:

In step S1 collecting of first data by the third processing unit at a first collection timepoint takes place, which is determined by adding the receiving timepoint to of the receiving of the synchronisation signal S by the third processing unit, an a first time offset Offset₁, or is a sum of the receiving timepoint to of the receiving of the synchronisation signal S by the third processing unit and a first time offset Offset₁.

The collection of the first data takes place over a first time duration TS1.

In step S2 collecting of second data by the second processing unit at a second collection timepoint takes place, which is determined by adding the receiving timepoint to of the receiving of the synchronisation signal S by the second processing unit, an a second time offset Offset₂, or is a sum of the receiving timepoint to of the receiving of the synchronisation signal S by the second processing unit and a second time offset Offset₂.

The collection of the second data takes place over a first time duration TS2.

Transmission or transferring of the first data from the third processing unit to the second processing unit takes place in step S3.

The transmission of the first data from the third processing unit to the second processing unit takes place over a third time duration TS3.

Transmission or transferring of the first and/or second data from the second processing unit to the first processing unit takes place in step S4.

The transmission of the first and/or second data from the second processing unit to the first processing unit takes place over a fourth time duration TS4.

Thus, at the timepoint T, all the data are present in the first processing unit.

A latency Latenz₁ is present between the start of the collecting of the first data and the timepoint T.

A latency Latenz₂ is present between the start of the collecting of the second data and the timepoint T.

The latencies Latenz₁ and Latenz₁ are for example dependent on the processing units and the construction of the system or the transmission paths, etc.

By the adjustment of the first time offset Offset₁ and/or of the second time offset Offset₂, the timepoint T can thus be shifted and/or adjusted or optimised.

The first period is followed by a second period, as can be seen from the repeated illustration of the time durations TS1, TS2 and TS3 in the right-hand region of FIG. 1.

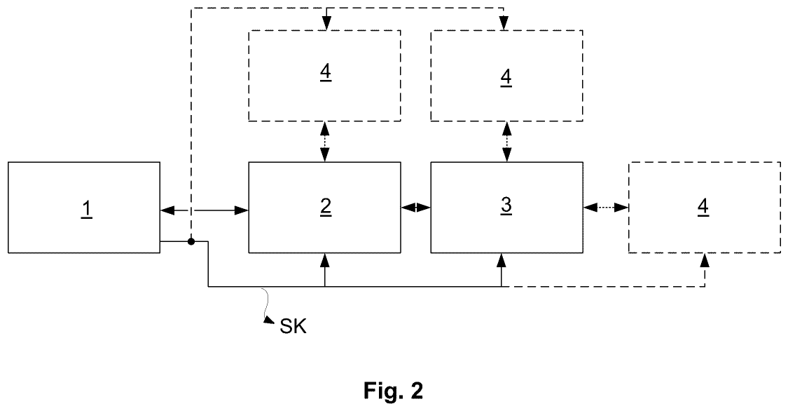

FIG. 2 shows a fundamental or general design of an embodiment of a system according to the disclosure and/or the transmission paths thereof. The system is part of an FCC.

The system comprises a first processing unit 1 in the form of a CPU. The first processing unit can also be referred to as the central processing unit.

The system further comprises a second and a third processing unit 2 and 3, each in the form of a FPGA.

The system can optionally be extended by further processing units 4, as is shown by the hatched squares in FIG. 2. These extensions make it possible to fulfil further requirements placed on the FCC.

The first processing unit 1 is communicatively connected to the second processing unit 2, and the second processing unit 2 is communicatively connected to the third processing unit 3, in each case via a data channel indicated by a double arrow in FIG. 2.

The optional processing units 4 can in each case be communicatively connected to one of second processing units 2 or 3 in each case, via a data channel indicated by a double arrow in FIG. 2. In this case, a plurality of optional processing units 4 can be communicatively connected to one of processing units 2 or 3.

The first processing unit 1 is connected to each processing unit 2, 3 and optionally 4 via a signal channel SK which is configured for transmitting synchronisation signals.

The synchronisation signals can also be transmitted via the data channel(s).

The first processing unit, as the master of the communication, provides all the other processing units of the system with a synchronisation signal. Depending on this synchronisation signal, the respective data are prepared, for example collected and/or transmitted, just at the necessary timepoint.

1. Computer-implemented method for transmitting data, comprising the steps of:
transmitting a synchronisation signal via a first processing unit;
receiving the synchronisation signal by a second and/or a third processing unit, at a receiving timepoint in each case;
transmitting first data from the third processing unit to the second processing unit, wherein the transmission of the first data takes place at a first transmission timepoint which depends on the respective receiving timepoint of the reception of the synchronisation signal by the second and/or third processing unit;
transmitting the first and/or second data from the second processing unit to the first processing unit, wherein the transmission takes place at a second transmission timepoint which depends on the respective receiving timepoint of the reception of the synchronisation signal by the second and/or third processing unit.

2. Computer-implemented method according to claim 1, wherein the first transmission timepoint is a sum of the receiving timepoint of the receiving of the synchronisation signal by the second and/or third processing unit, a first time offset, and/or a time duration, and/or in that the second transmission timepoint is the sum of the receiving timepoint of the receiving of the synchronisation signal by the second and/or third processing unit, a second time offset, and/or a time duration.

3. Computer-implemented method according to claim 2, wherein the method comprises the step, before transmitting of first data from the third processing unit to the second processing unit, of:
collecting the first data by means of the third processing unit.

4. Computer-implemented method according to claim 3, wherein the method comprises the step, before transmitting of the first data and/or of the second data from the second processing unit to the first processing unit, of:
collecting the second data by means of the second processing unit.

5. Computer-implemented method according to claim 3, wherein the collecting of the first data takes place at a first collection timepoint, which is a sum of the receiving timepoint of the receiving of the synchronisation signal by the second and/or third processing unit, and of the first time offset, and/or in that the collecting of the second data takes place at a second collection timepoint, which is a sum of the receiving timepoint of the receiving of the synchronisation signal by the second and/or third processing unit, and of the second time offset.

6. Computer-implemented method according to claim 1, wherein the method the transmission of the first data and/or of the second data from the second processing unit to the first processing unit takes place via exactly one data channel.

7. Computer-implemented method according to claim 1, wherein the steps of the method are carried out multiple times.

8. Computer-implemented method according to claim 1, wherein the first and/or the second transmission timepoint is adjusted.

9. System comprising a first, second and third processing unit, which are in each case configured so as to carry out a method according to claim 1.

10. System according to claim 9, wherein the first, second and/or third processing unit in each case comprise or constitute a processor.

11. System according to claim 10, wherein the first, second and/or third processing unit are connected directly or indirectly via a data channel.

12. System according to claim 9, wherein the system is a component of a flight control of an aircraft.

13. Computer-implemented method according to claim 1 including flight control operation of an aeroplane.

14. Computer-implemented method according to claim 1, wherein the steps of the method are carried out periodically.

15. Computer-implemented method according to claim 1, wherein the first and/or the second transmission timepoint is adjusted to a latency of the third and/or second processing unit in each case.

16. System according to claim 10, wherein the first, second and/or third processing unit are connected directly or indirectly via a high speed data bus.
